(19) United States
(12) Patent Application Publication
(10) Pub. No.: US 2010/0281474 A1
(43) Pub. Date: Nov. 4, 2010

(54) FIRMWARE UPDATING

(76) Inventors: Patrick C. Eason, Houston, TX (US); Phillip A. Leech, Houston, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/433,395

(22) Filed: Apr. 30, 2009

(51) Int. Cl. G06F 9/44

(52) U.S. Cl. 717/172; 709/220

(57) ABSTRACT

Updating firmware of remote devices is useful to administrators of such devices. Various embodiments provide for activating a process on a plurality of remote devices to update the firmware of each respective remote device. By monitoring the process for indications of when each respective remote device is ready for a subsequent event, the process of updating the firmware can be automated. Additional embodiments include verifying that each remote device has been updated as expected.

### BACKGROUND

Enterprise solutions may involve hundreds of multiple-server enclosures spread across a number of physical locations. It is common in providing additional functionality, or fixing problems, for these enclosures to provide updates to the firmware providing management facilities to these enclosures. In such large-scale environments, performing firmware updates manually would be a time consuming effort and could be error prone. The potential to flash the wrong version of the firmware for these management facilities or missing some of these management facilities is present.

Prior solutions have utilized windowed processes, such as TELNET, to manually access individual remote devices and to update one or more instances of device firmware. However, prematurely terminating a TELNET session during the firmware update procedure may cause unintended consequences, such as losing configuration data or causing the management facility to be inaccessible remotely, resulting in the need to perform one or more local activities, such as a manual reset of the management facility.

For the reasons stated above, and for other reasons that will become apparent to those skilled in the art upon reading and understanding the present specification, there is a need in the art for alternative methods and apparatus for updating firmware of remote devices.

### BRIEF DESCRIPTION OF THE DRAWINGS

FIG. 1 is a representation of a computer system for use with various embodiments of the disclosure.

FIGS. 2A-2C represent flowcharts of a firmware update process in accordance with an embodiment of the disclosure.

FIGS. 3A-3C represent flowcharts of a firmware update verification process in accordance with an embodiment of the disclosure.

FIGS. 4A-4D represent flowcharts of a firmware update process in accordance with an embodiment of the disclosure.

### DETAILED DESCRIPTION

In the following detailed description of the present embodiments, reference is made to the accompanying drawings that form a part hereof, and in which is shown by way of illustration specific embodiments of the disclosure which may be practiced. These embodiments are described in sufficient detail to enable those skilled in the art to practice the subject matter of the disclosure, and it is to be understood that other embodiments may be utilized and that process or mechanical changes may be made without departing from the scope of the present disclosure. The following detailed description is, therefore, not to be taken in a limiting sense, and the scope of the present disclosure is defined by the appended claims and equivalents thereof.

Automating the updating of firmware of remote devices is useful to administrators of such devices. Various embodiments provide for activating a process on a plurality of remote devices to update the firmware of each respective remote device. For example, a TELNET session can be initiated on each remote device to effect the firmware update. By monitoring the process for indications of when each respective remote device is ready for a subsequent event, the process of updating the firmware can be automated. For example, a session log file can be monitored to determine what is occurring on the remote device. Thus, as the remote device responds, that text can be viewed in the log file to determine when a response indicates a desired status, e.g., ready to log on or completion of the firmware update. No further input from the administrator is necessary as described herein. Additional embodiments include verifying that each remote device has been updated as expected.

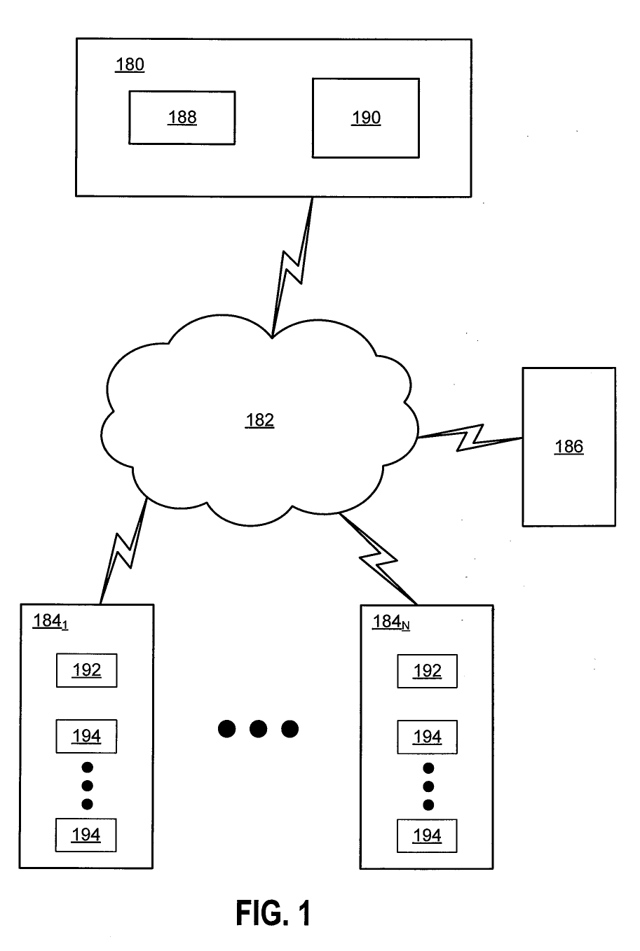

FIG. 1 is a representation of a computer system for use with various embodiments of the disclosure. The computer system includes a host device 180 in communication with a network 182, two or more remote devices 184 in communication with the network 182, and a storage medium 186 in communication with the network 182. The network 182 may represent the Internet, a local area network (LAN), a wide area network (WAN) or any other type of network providing for communication between multiple electronic devices. The network 182 may further represent some combination of various network types.

The host device 180 is a computing device including a processor 188 and a storage medium 190. The storage medium 190 contains machine-readable instructions adapted to cause the processor 188 to perform one or more methods in accordance with embodiments of the disclosure. The machine-readable instructions can be in a variety of programming languages. In general, the programming language should be capable of activating a process on the remote device. While the example embodiments will be described in relation to windowed processes, such as TELNET, embodiments could utilize other interfaces, such as a SOAP (Simple Object Access Protocol) interface or a GUI (Graphical User Interface). Example programming languages include Visual Basic, PERL (Practical Extraction and Report Language), Python, Java, C#, Microsoft.NET, etc. The programming language should further be capable of sending keystrokes to the session window or have an automation object with an interface to perform the equivalent of sending keystrokes or other programmatic commands. The programming language should further be capable of reading from and writing to files, initiating a process via the command line, and killing an active process on the remote device 184. As good practice, the host device 180 should be configured to not activate a screen saver or otherwise suspend activity while performing a method of an embodiment described herein. The host device 180 may represent a server computer usable by an administrator of the computer system to communicate with each of the remote devices 184.

The storage medium 186 contains at least the firmware binary, i.e., machine-readable instructions adapted to cause a remote device 184 to update its firmware. The storage medium 186 may be separate from the host device 180 and the remote devices 184, or it may be a component of the host device 180 or one of the remote devices 184. As one example, the storage medium 186 may represent an FTP (File Transfer Protocol) server hosting the firmware binary.

Each remote device 184 includes a management facility 192. As one example, a remote device 184 may represent an enclosure containing one or more servers 194 managed by the management facility 192. Communication between the host device 180 and the remote devices 184 is facilitated by an IP (Internet Protocol) address or other addressing scheme through which the host device 180 can designate for which of the remote devices 184 a particular communication is intended.

While an administrator of the computer system could effect updates to the firmware of the remote devices 184 individually, various embodiments described herein provide for automating the update process, thereby facilitating a reduction in errors, e.g., forgetting to update a remote device 184 or providing an incorrect version of the firmware to a remote device 184. By utilizing a windowed process on each remote device 184, and monitoring the windowed process for indicators of a status of the respective remote device 184, such firmware updates can be effected while mitigating the risk of premature termination of the windowed process.

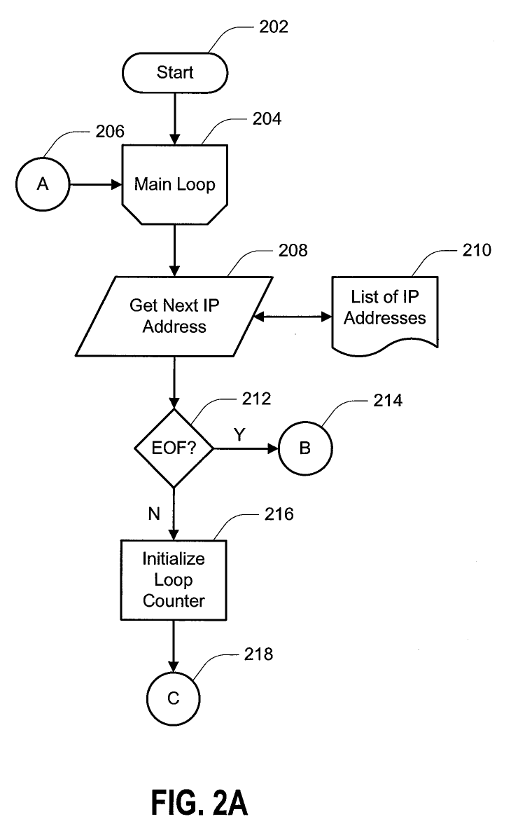

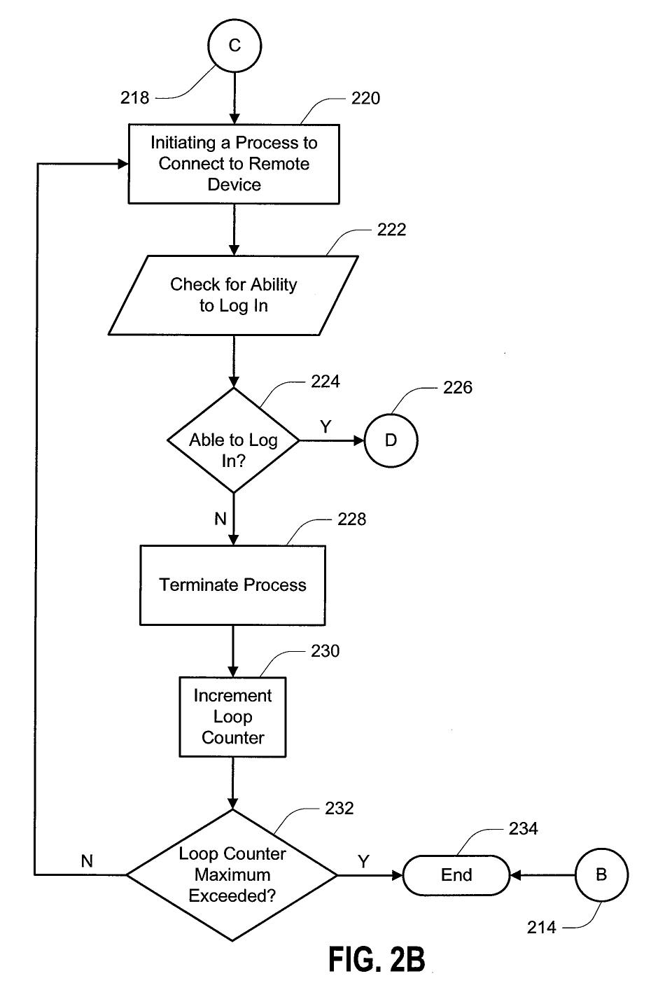

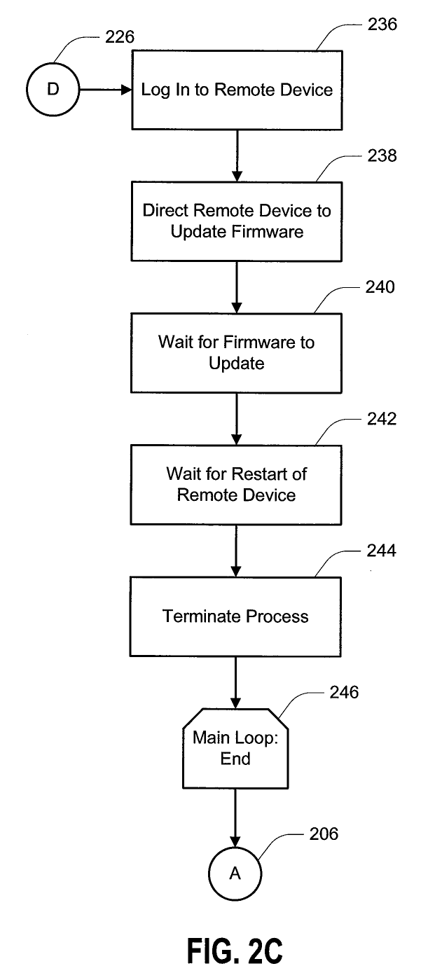

FIGS. 2A-2C represent flowcharts of a firmware update process in accordance with an embodiment of the disclosure. The process begins at 202. A main loop is initiated at 204. This loop represents the process performed for each remote device. Although represented in the flowcharts of FIGS. 2A-2C as performing this loop on each remote device in a serial fashion, i.e., one remote device at a time, it will be apparent that if the host device and its programming language is capable of multi-threaded processing and the concurrent operation of multiple windowed processes, this loop could be performed on two or more of the remote devices concurrently.

At 208, a next IP address is obtained from a list of IP addresses 210. The list of IP addresses 210 represents the list of IP addresses of each of the remote devices upon which the firmware update process is to be performed. At 212, a decision if made whether an EOF (End-of-File) indication is received while attempting to obtain the next IP address. If yes, the process proceeds to 214 and ends at 234. If no, the process proceeds to 216 where a loop counter is initialized. The loop counter facilitates determining whether some failure to log in to a remote device is encountered. From 216, the process proceeds to 218 and then to 220, where a connection is established to a remote device using a windowed process.

At 222, the ability to log in to the remote device is checked. A decision is made at 224 whether a log-in is possible. If yes, the process proceeds to 226 to begin log-in at 236. If no, the windowed process is terminated at 228 and the loop counter is incremented at 230. At 232, the counter is evaluated to see whether some predetermined limit on the number of log-in attempts is exceeded. For example, the loop counter may be set at ten, such that ten attempts are made to log in to a remote device before it is deemed a failure. If the loop counter is exceeded at 232, the process can be ended at 234. Alternatively, an indication of the failure may be provided prior to ending the process, and/or the process may proceed to 206 such that a next remote device can be addressed. If the loop counter is not exceeded at 232, the process can return to 220 to again attempt the connection/log-in process.

At 236, the process logs in to the remote device and directs the remote device to update its firmware at 238. The process waits for the firmware to update at 240, then waits for the remote device to restart at 242. After restarting of the remote device, the process terminates the windowed process at 244 and the main loop is completed at 246. The process then proceeds to 206 such that a next remote device can be addressed.

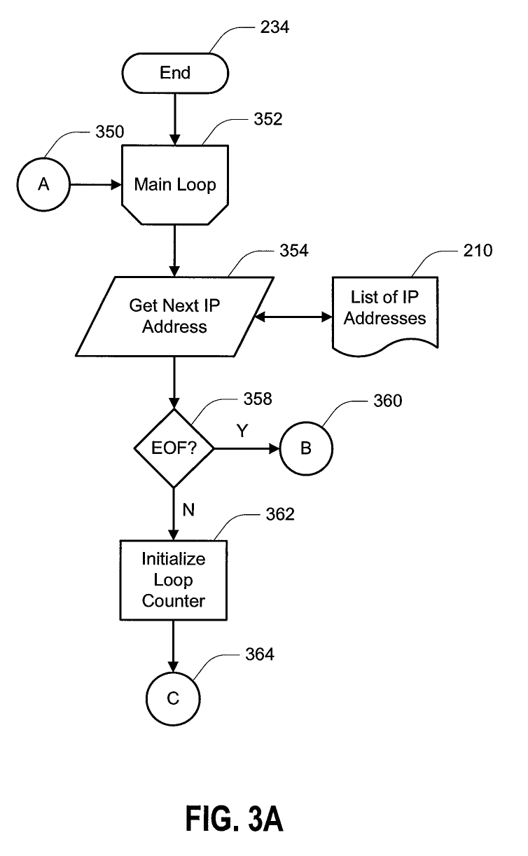

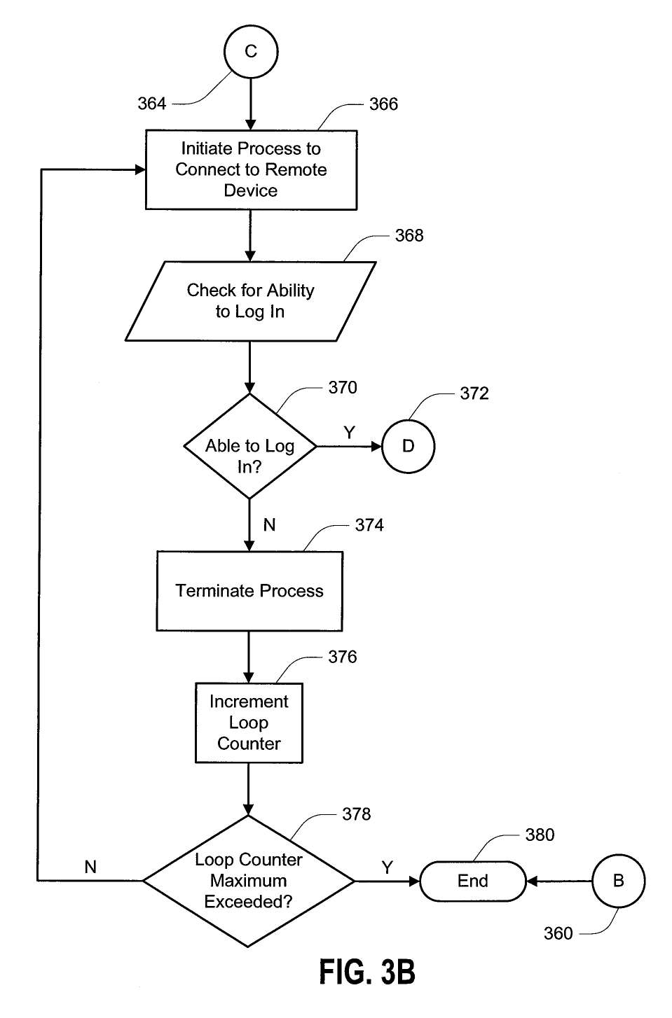

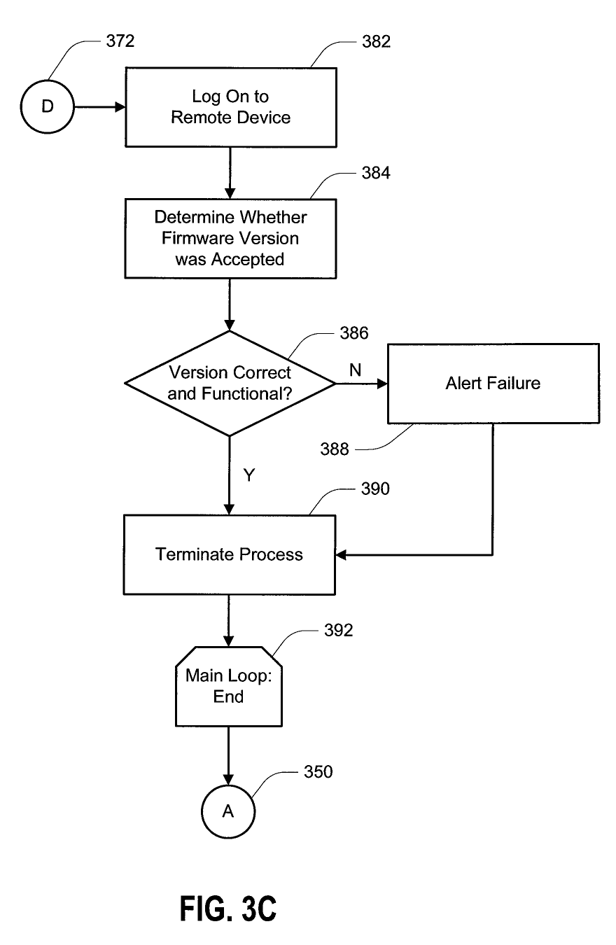

For one or more embodiments, following updates of firmware, the process may return to verify the firmware of the remote devices updated as expected. FIGS. 3A-3C represent flowcharts of a firmware update verification process in accordance with an embodiment of the disclosure. The verification process begins at 234 of the update process of FIGS. 2A-2C. A main loop is initiated at 352. This loop represents the process performed for each remote device. Although represented in the flowcharts of FIGS. 3A-3C as performing this loop on each remote device in a serial fashion, i.e., one remote device at a time, it will be apparent that if the host device and its programming language is capable of multi-threaded processing and the concurrent operation of multiple windowed processes, this loop could be performed on two or more of the remote devices concurrently.

At 354, a next IP address is obtained from the list of IP addresses 210. The list of IP addresses 210 represents the list of IP addresses of each of the remote devices upon which the firmware update process was performed in FIGS. 2A-2C. At 358, a decision if made whether an EOF (End-of-File) indication is received while attempting to obtain the next IP address. If yes, the process proceeds to 360 and ends at 380. If no, the process proceeds to 362 where a loop counter is initialized. The loop counter facilitates determining whether some failure to log in to a remote device is encountered. From 362, the process proceeds to 364 and then to 366, where a connection is established to a remote device using a windowed process.

At 368, the ability to log in to the remote device is checked. A decision is made at 370 whether a log-in is possible. If yes, the process proceeds to 372 to begin log-in at 382. If no, the windowed process is terminated at 374 and the loop counter is incremented at 376. At 378, the counter is evaluated to see whether some predetermined limit on the number of log-in attempts is exceeded. For example, the loop counter may be set at ten, such that ten attempts are made to log in to a remote device before it is deemed a failure. If the loop counter is exceeded at 378, the process can be ended at 380. Alternatively, an indication of the failure may be provided prior to ending the process, and/or the process may proceed to 350 such that a next remote device can be addressed. If the loop counter is not exceeded at 378, the process can return to 366 to again attempt the connection/log-in process.

At 382, the process logs in to the remote device and confirms what firmware version the remote device contains at 384. At 386, a decision is made whether the firmware version is correct and functional. If yes, the windowed process is terminated at 390. If no, the failure is alerted at 388, such as through a screen flash, email, log entry or other indication to the administrator and the windowed process is terminated at 390. Following termination of the windowed process, the main loop is complete at 392 and the process proceeds to 350 such that a next remote device can be addressed.

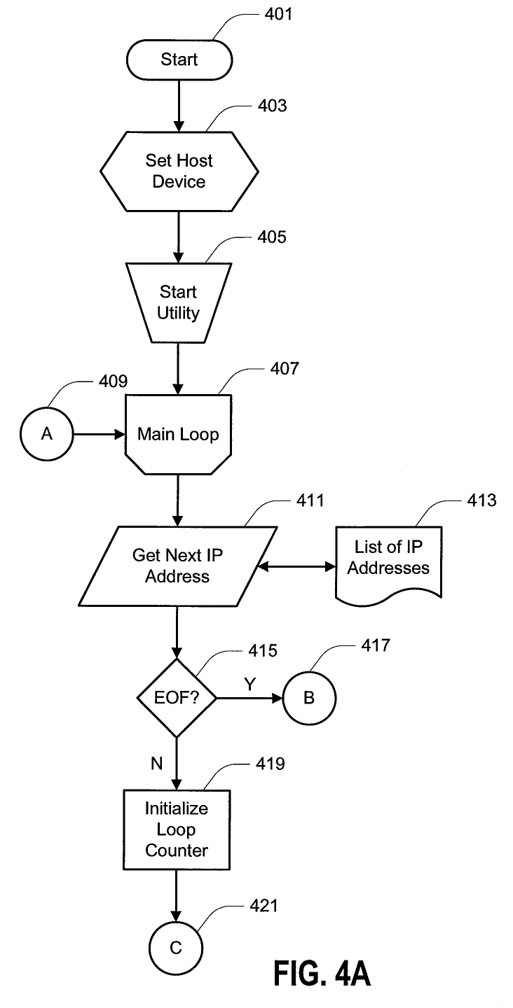

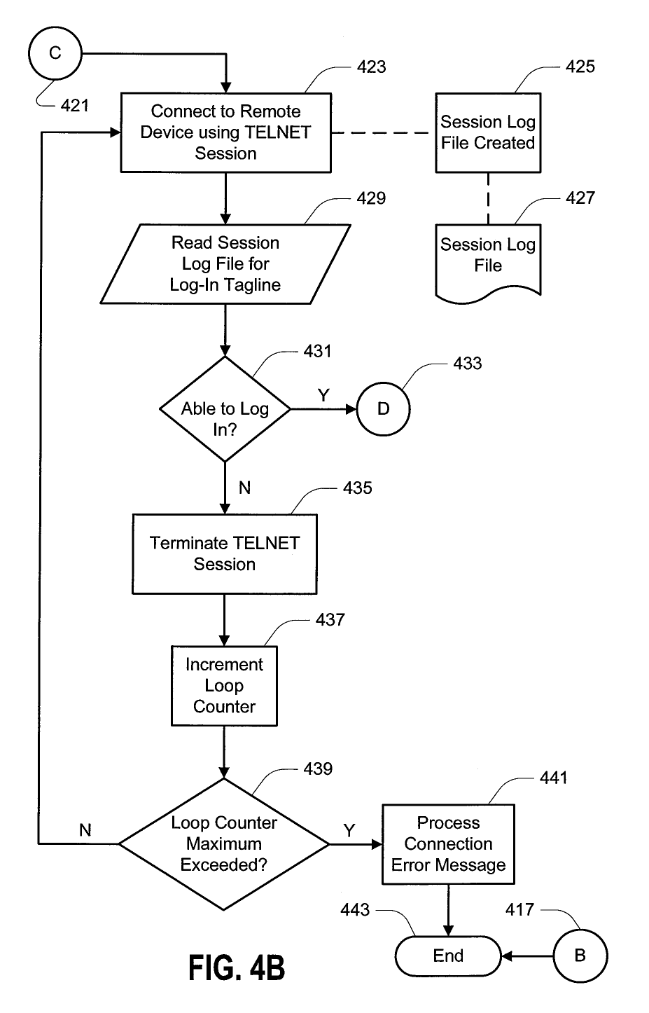

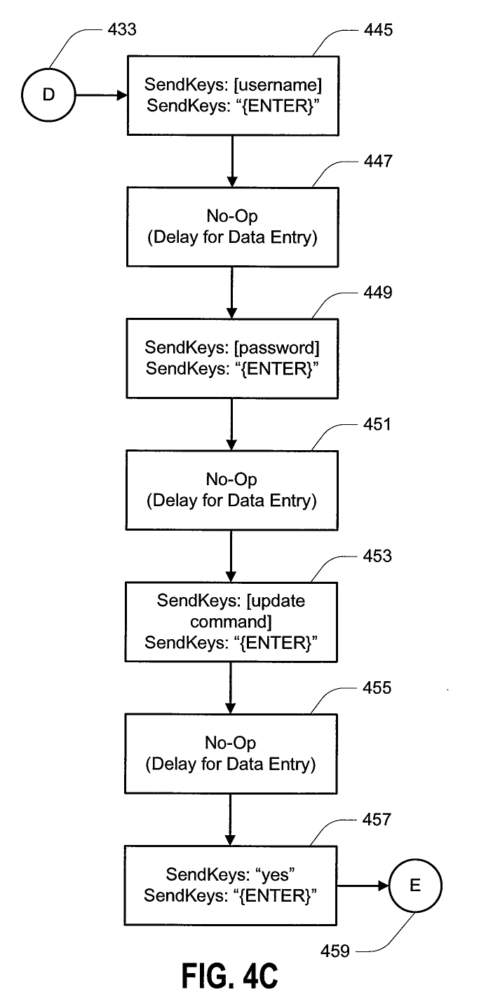

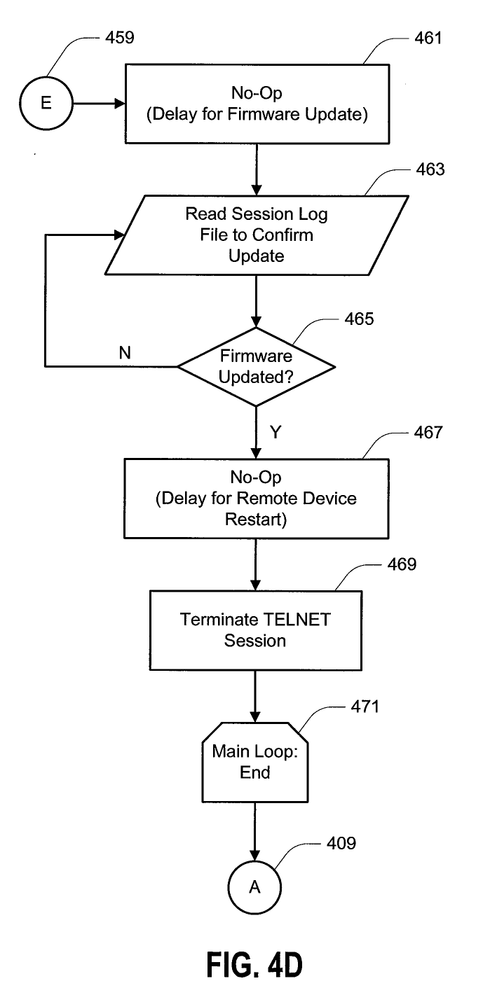

FIGS. 4A-4D represent flowcharts of a firmware update process in accordance with another embodiment of the disclosure. The process of FIGS. 4A-4D represent a process using the Visual Basic programming language and TELNET sessions on each remote device. The process begins at 401. Host device configuration is set at 403. For example, the host device may be set to disable its screen saver and to set its suspend timer to NEVER. The administrator then begins the utility at 405 to proceed to the main loop at 407. This loop represents the process performed for each remote device. Although represented in the flowcharts of FIGS. 4A-4D as performing this loop on each remote device in a serial fashion, i.e., one remote device at a time, it will be apparent that if the host device and its programming language is capable of multi-threaded processing and the concurrent operation of multiple windowed processes, this loop could be performed on two or more of the remote devices concurrently.

At 411, a next IP address is obtained from a list of IP addresses 413. The list of IP addresses 413 represents the list of IP addresses of each of the remote devices upon which the firmware update process is to be performed. At 415, a decision if made whether an EOF (End-of-File) indication is received while attempting to obtain the next IP address. If yes, the process proceeds to 417 and ends at 443. If no, the process proceeds to 419 where a loop counter is initialized. The loop counter facilitates determining whether some failure to log in to a remote device is encountered. From 419, the process proceeds to 421 and then to 423, where a connection is established to a remote device using a TELNET session. As part of the TELNET sessions, a session log file 427 is created at 425. The TELNET session pipes all commands and responses, sent and received, into this file. For example, the keys “cmd/c % systemroot % \system32\telnet.exe [IPAddress]-F [TelnetSessionLog]” could be sent to the remote device to initiate the TELNET session and create the log file, where [IPAddress] represents the IP address of the remote device and [TelnetSessionLog] represents the file location for the log file.

At 429, the log file 427 is read to look for a log-in tagline. For example, the remote device may return “HP Blade PC BL e-Class Integrated Administrator” when it is ready to accept a log-in attempt. If this text is located in the log file 427, the process proceeds to 433 and then to 445 to begin the log-in procedure. If this text is not located in the log file 427, the TELNET session is terminated at 435 and the loop counter is incremented at 437. At 439, the counter is evaluated to see whether some predetermined limit on the number of log-in attempts is exceeded. For example, the loop counter may be set at ten, such that ten attempts are made to log in to a remote device before it is deemed a failure. If the loop counter is exceeded at 439, a process connection error message is generated at 441 and the process can then be ended at 443. Alternatively, after the error message is generated at 441, the process may proceed to 409 such that a next remote device can be addressed. If the loop counter is not exceeded at 439, the process can return to 423 to again attempt the connection/log-in process.

At 445, the username is sent to the remote device. For one embodiment, the username is the same for each remote device. For another embodiment, the list of IP addresses 413 may further contain a username corresponding to each IP address. A no-op is then performed at 447 to delay for the acceptance of the data entry. For example, the no-op may be a delay of two seconds. At 449, the password is sent to the remote device. For one embodiment, the password is the same for each remote device. For another embodiment, the list of IP addresses 413 may further contain a password corresponding to each IP address. A no-op is then performed at 451 to delay for the acceptance of the data entry. For example, the no-op may be a delay of two seconds.

At 453, the update command is sent to the remote device. For example, in Hewlett-Packard CCI (Consolidated Client Infrastructure) environment, the command line “update image ftp://[IPAddress]/[newIAfirmware]” may be sent to the remote device, where [IPAddress] represents the IP address of the storage medium 186 and [newIAfirmware] represents the file location of the firmware binary within the storage medium 186. A no-op is then performed at 455 to delay for the acceptance of the data entry. For example, the no-op may be a delay of two seconds. At 457, the desire to update the firmware is confirmed, such as by sending the response “yes” to the remote device, and the process then proceeds to 459. From 459, a no-op may be performed at 461 to delay for the firmware to be updated. For example, if it is expected that the firmware update will take 3.5 minutes, the no-op 461 can represent a delay of 3.5 minutes.

At 463, the session log file 427 is read to look for a tagline or other indication that the firmware has been updated. For example, the remote device may return “New firmware image flashed” when the firmware update is complete. A decision is then made at 465 whether the firmware has been updated. If the tagline or other indication is located in the log file 427, the process proceeds to 467. Otherwise, the process returns to 463 to read the log file 427 again. It is noted that the no-op 461 could be eliminated, but delaying for a time needed to perform the firmware update can reduce unnecessary reading of the log file 427.

It is noted that following an indication that the firmware update is complete, the remote device will restart. This restarting process does not terminate the TELNET session. However, if the host device terminates the TELNET session before the remote device completes its restart, it may lead to an inability to log back into the remote device. The recourse is to manually RESET the management facility of the remote device, which can lead to loss of all previously set configurations. To mitigate this risk, a no-op 467 can be performed to delay for this restart of the management facility. For example, if the management facility is expected to restart in less than ten seconds after providing the indication that the firmware update is complete, the no-op 467 can be a delay of at least ten seconds. The TELNET session is then terminated at 469 and the main loop is complete at 471. For example, the command line “cmd /c taskkill /F /IM telnet.exe /T” could be sent to the remote device. This will force all running TELNET processes and its child processes to close. The process can then proceed to 409 such that a next remote device can be addressed. As with the process of FIGS. 2A-2C, the process of FIGS. 4A-4D could include a firmware verification process similar to that described with reference to FIGS. 3A-3C.

Although specific embodiments have been illustrated and described herein it is manifestly intended that the scope of the claimed subject matter be limited only by the following claims and equivalents thereof.

What is claimed is:

1. A method of operating a host device of a computer system having two or more remote devices in communication with the host device, the method comprising:
for each of the remote devices, obtaining an IP address of a remote device at the host device;
initiating a process to connect to the remote device;
checking for an indication of an ability to log in to the remote device;
logging in to the remote device if able;
directing the remote device to update its firmware;
waiting for an indication of completion of the firmware update;
upon the indication of completion, waiting for the remote device to restart; and
terminating the process.

2. The method of claim 1, wherein obtaining an IP address comprises obtaining the IP address from a list containing the IP address of each of the two or more remote devices.

3. The method of claim 2, further comprising ending the method when an end-of-file is reached in the list.

4. The method of claim 1, further comprising:
terminating the process if unable to log in;
re-initiating the process to connect to the remote device;
checking again for an indication of an ability to log in to the remote device; and
logging in to the remote device if able.

5. The method of claim 1, further comprising creating a log file for storing commands and responses of the process.

6. The method of claim 5, wherein checking for an indication of an ability to log in to the remote device comprises checking the log file for text indicating an ability to log in to the remote device.

7. The method of claim 5, wherein waiting for an indication of completion of the firmware update comprises checking the log file for text indicating completion of the firmware update.

8. The method of claim 1, wherein waiting for the remote device to restart comprises waiting for at least a particular time in which the remote device is expected to restart after completion of the firmware update.

9. The method of claim 1, wherein the host device performs the method on two or more remote devices concurrently.

10. The method of claim 1, further comprising confirming that the remote device updated its firmware as expected.

11. A method of operating a host device of a computer system having two or more remote devices in communication with the host device, the method comprising:
obtaining an IP address of a remote device from a list containing IP addresses of each of the two or more remote devices;
initiating a TELNET session on the remote device including creation of a session log file;
checking the session log file for text indicating an ability to log in to the remote device;
logging in to the remote device if able;
sending a firmware update command to the remote device;
waiting for text to appear in the session log file indicating completion of the firmware update;
upon the indication of completion, waiting for the remote device to restart; and
terminating the TELNET session.

12. The method of claim 11, further comprising:
obtaining a next IP address from the list containing IP addresses of each of the two or more remote devices;
initiating a TELNET session on the remote device corresponding to the next IP address including creation of a next session log file;
checking the next session log file for text indicating an ability to log in to the corresponding remote device;
logging in to corresponding remote device if able;
sending a firmware update command to the corresponding remote device;
waiting for text to appear in the next session log file indicating completion of the firmware update;
upon the indication of completion, waiting for the corresponding remote device to restart; and
terminating the TELNET session for the corresponding remote device.

13. The method of claim 12, further comprising repeating the progression of obtaining a next IP address from the list through terminating the TELNET session for the corresponding remote device until an end-of-file indication is received from the list.

14. The method of claim 13, further comprising:
obtaining an IP address of a remote device from the list containing IP addresses of each of the two or more remote devices;
initiating a TELNET session on the remote device including creation of a session log file;
checking the session log file for text indicating an ability to log in to the remote device;
logging in to the remote device if able;
determining whether the firmware update was accepted for the remote device;
alerting a failure if the firmware update is not the correct version or is not functional; and
terminating the TELNET session.

15. The method of claim 14, further comprising:
obtaining a next IP address from the list containing IP addresses of each of the two or more remote devices;
initiating a TELNET session on the remote device corresponding to the next IP address including creation of a next session log file;
checking the next session log file for text indicating an ability to log in to the corresponding remote device;
logging in to corresponding remote device if able;
determining whether the firmware update was accepted for the corresponding remote device;
alerting a failure if the firmware update is not the correct version or is not functional; and
terminating the TELNET session for the corresponding remote device.

16. A computing device, comprising:
a processor; and
a storage medium containing machine-readable instructions adapted to cause the processor to perform a method of updating firmware of two or more remote devices in communication with the computing device, the method comprising:
for each of the remote devices, obtaining an IP address of a remote device;
initiating a process to connect to the remote device;
checking for an indication of an ability to log in to the remote device;
logging in to the remote device if able;
directing the remote device to update its firmware;
waiting for an indication of completion of the firmware update;
upon the indication of completion, waiting for the remote device to restart; and
terminating the process.

17. The computing device of claim 16, wherein the machine-readable instructions are further adapted to cause the processor to obtain the IP address from a list containing the IP address of each of the two or more remote devices.

18. The computing device of claim 17, wherein the machine-readable instructions are further adapted to cause the processor to end the method when an end-of-file is reached in the list.

19. The computing device of claim 16, wherein the machine-readable instructions are further adapted to cause the processor to perform the method on two or more remote devices concurrently.

20. The computing device of claim 16, wherein the machine-readable instructions are further adapted to cause the processor to confirm that the remote device updated its firmware as expected.
